(19) United States
(12) Patent Application Publication
(10) Pub. No.: US 2006/0102365 A1
(43) Pub. Date: May 18, 2006

(54) Fastener system

(76) Inventors: Alan Phillips, Jackson, TN (US); John M. Beville, Columbia, SC (US)

Correspondence Address: THE BLACK & DECKER CORPORATION, 701 EAST JOPPA ROAD, TW199, TOWSON, MD, 21286, US

(21) Appl. No.: 11/010,637

(22) Filed: Dec. 13, 2004

Related U.S. Application Data
(60) Provisional application No. 60/529,199, filed on Dec. 12, 2003.

(51) Int. Cl. B25D 11/00

(52) U.S. Cl. 173/130; 173/156

(57) ABSTRACT

The present invention generally relates to the field of fasteners and particularly to a portable fastener system. An aspect of the present invention is directed to a fastener system having a reservoir for storing propellant; and, a fastener device connected with the reservoir; wherein the reservoir is configured for storing propellant at a pressure greater than two hundred (200) psi and delivering the propellant to the fastener device.

### CROSS-REFERENCE

The present application claims priority under 35 U.S.C. §119(e) to U.S. Provisional Patent Ser. No. 60/529,199, entitled: Fastener System, filed on Dec. 12, 2003, which is hereby incorporated by reference in its entirety.

### FIELD OF THE INVENTION

The present invention relates to the field of fasteners and particularly to a portable fastener system.

### BACKGROUND OF THE INVENTION

For a number of woodworkers and construction workers, current fastener systems may be impractical for use on some jobsites. For example, pneumatic fastener systems may require access to a power source to operate a compressor, or may further require long lengths of hose or an extension cord to access a remote power supply. Alternatively, combustion fastener systems, while increasing portability, may be less cost effective, create waste containers, require combustible fuel, or the like.

### SUMMARY OF THE INVENTION

Accordingly, a first aspect of the present invention is directed to a fastener system having a reservoir for storing propellant; and, a fastener device connected with the reservoir; wherein the reservoir is configured for storing propellant at a pressure greater than two hundred (200) psi and delivering the propellant to the fastener device.

An additional aspect of the present invention is directed to a method for securing one or more fasteners including the steps of: storing propellant within a reservoir at a first pressure; delivering propellant from the reservoir to a connected fastener device at a second pressure; and, utilizing the propellant to secure one or more fasteners; wherein the first pressure is greater than two hundred (200) psi.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

FIG. 1 is an isometric view of a fastener system in accordance with an embodiment of the present invention.

### DETAILED DESCRIPTION OF THE INVENTION

Reference will now be made in detail to the presently preferred embodiments of the invention, examples of which are illustrated in the accompanying drawings.

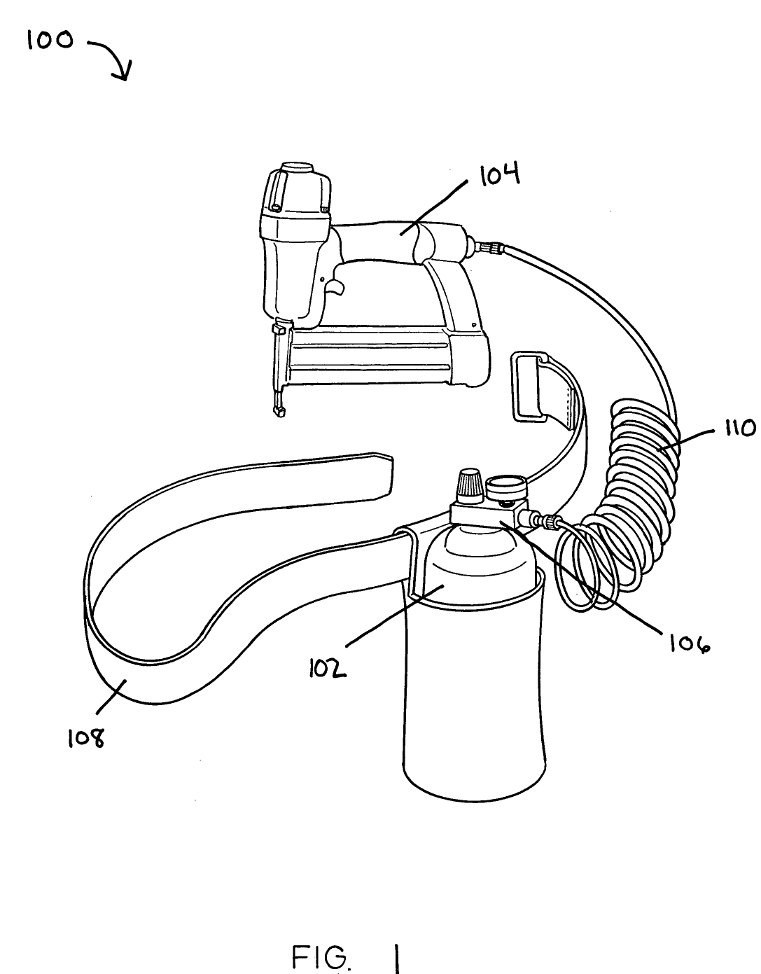

Referring to FIG. 1, a fastener system 100 in accordance with an embodiment of the present invention is shown. In a first aspect of the invention, a fastener system 100 includes a reservoir 102 for containing propellant, and a fastener device 104, such as a pneumatic-type fastener device. Additionally, the system may include: a regulator 106, e.g., two stage regulator, for controlling flow pressure; an apparatus included with the fastener device, e.g., a trigger valve, for controlling the amount of propellant per shot (fastener secured); a carrying apparatus 108 (such as a back-pack or belt/pouch) for carrying various components and accessories, e.g., the reservoir, additional fasteners and the like); a transfer hose 110 (for allowing the reservoir to be disposed remote from the fastener device, e.g. a coiled hose or the like for easy transport); a fill indicator, such as to indicate the amount of propellant remaining in the reservoir; and, a safety valve for allowing for propellant release due to pressure build-up to prevent wear or to limit the propellant released to damage to the fastener device. Preferably, a reservoir is of a suitable size and weight to be transported by a user as he or she conducts routine activities, without interfering with his/her movements.

In the present aspect, a fastener system includes a reservoir for storing propellant. Suitable propellants include compressed air, carbon dioxide (CO₂), compressed nitrogen, or the like for driving a fastening device. Suitable propellants may be stored as a gas, a liquid or in multiple phases. Those of skill in the art will appreciate that additives may be included with the propellant such as a trace amount of oil for lubricating the fastener, a desiccant to remove water vapor (which may be contained in a connected annex container), or the like to increase performance, or to reduce wear. Preferably, the propellant is sufficiently compressible (without undue difficulty) to allow for an acceptable number of shots (fasteners driven per reservoir refill or replacement) without adversely impacting portability. For instance, carbon dioxide (CO₂) may be utilized due to its relative availability (such as in welding supply stores or paint ball shops, which allow for refill or exchange of the reservoir), its compressible nature (e.g., ability to be contained in a combination liquid/gas phase), its generally inert nature, ease of transport, and the like. For example, a reservoir, such as a canister, containing in the range of one point two five pounds (1.25 pounds) to two point five pounds (2.5 pounds) of CO₂ may be utilized. While the previous range of contained propellant may be preferred to allow for portability, the size of the reservoir may vary depending on the propellant selected, the number of shots desired and the like. For instance, a 1.9 pound (one point nine pound) cylinder may be utilized without adversely impacting user activities. For example, a 1.3 pound cylinder containing CO₂, when implemented with a brad nailer or small stapler, may secure approximately 850 (or in the range of 800-900) fasteners per refill (depending on the fastener device being utilized). A finish nailer or medium stapler may secure approximately 450 (or in the range of 400-500) fasteners per refill, while a framing nailer (driving sixteen penny nails) may secure approximately 200 (or in the range of 150-250) fasteners per refill. Those of ordinary skill in the art will appreciate that the number of fasteners may vary based on the system configuration such as propellant utilized, condition of the fastener device, fastener device configuration, connection of a transfer device such as a transfer hose and connections and the like. For example, a compressed air system with a 1.3 pound cylinder, when implemented with a brad nailer or small stapler, may secure approximately 250 (or in the range of 200-300) fasteners per refill (depending on the system's configuration), a finish nailer or medium stapler may secure approximately 150 (or in the range of 100-200) fasteners per refill, while a framing nailer (driving sixteen penny nails) may secure approximately 50 (or in the range of 20-100) fasteners per refill. Those of skill in the art will appreciate that the foregoing ranges are dependent on the pressurization of the propellant. For example, the contained propellant may be pressurized in the range of approximately 1000 psi (pounds per square inch) to 3000 psi (pounds per square inch). Preferably, the system may be pressurized to approximately 1800 psi to allow for a sufficient quantity of shots while minimizing the required size of the reservoir, minimizing the pressure required, and the like.

In additional embodiments, a smaller reservoir, such as to allow direct connection to the fastener device, is contemplated. For example, the present system may allow for connection of a reservoir directly to a fastener device or through a regulator, e.g., a two stage regulator, so that a pneumatic fastener device may be utilized in a portable fashion. For example, a user may wish to utilize a compact portable fastening system when securing crown molding on a ladder. Thus, the user may disconnect a pneumatic fastener device (such as a fastener device operating at a working pressure of 90 psi) from a pneumatic hose coupled to a compressor in favor of a reservoir containing sufficient propellant for a limited number of shots, e.g., 100 shots of a brad type nailer).

In additional embodiments, a compressor booster configured for refilling the system reservoir may be included as part of a kit with the fastening system of the present invention. For instance, a compressor booster may be configured for implementation with a standard compressor (a compressor operating in the range of approximately 100-200 psi (one hundred to two hundred pounds per square inch)) such that the pressure output may be sufficiently increased to pressurize the system reservoir to within the range of 1,000-2,000 (one thousand to two thousand pounds per square inch). Alternatively, a transfer system may be configured and included as part of a kit containing the fastening system of the present invention to allow a user to refill the fastener system reservoir from a propellant source, such as may be obtained from a commercial source. For example the transfer system may include one or more standard connectors, each standard connector configured for connection to the fastener system reservoir and suitable for transferring a particular type of propellant to the reservoir from a propellant source. Including various standard connectors allows a user to refill the fastener system reservoir with any one of a variety of corresponding propellants, as dictated by user preference.

In further embodiments, the fastener system may include one or more filler vessels from which a user may refill the fastener system reservoir. The filler vessels may include one of a variety of propellants, such as carbon dioxide, compressed air or the like. The filler vessel may be configured to refill a fastener system reservoir an acceptable number of times prior to exhaustion of the filler vessel's propellant supply. 100141 Additionally the fastener system's pressure may be varied so as to accommodate other system components, for ease of refilling, or the like. Preferably, the reservoir is formed from light weight material such as aluminum, reinforced plastics, composites, or the like for maximizing portability. In further embodiments, the reservoir may be formed of other suitable materials such as steel, or the like which are capable of containing the propellant material, so as to minimize cost or the like.

In a further aspect, a fastener system of the present invention is configured to permit a user to implement existing fastener devices such as pneumatic nailers, pneumatic staplers, palm nailers, and the like as part of the fastener system. In such instances, it may be desirable to configure or allow for the delivery of propellant at the working range of pressures for the fastener device being utilized. In further embodiments, a fastener device is configured for the propellant being utilized so as to maximize system capabilities based on the propellant's characteristics.

It is believed that the system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A fastener system, comprising:
a reservoir for storing propellant; and,
a fastener device connected with the reservoir;
wherein the reservoir is configured for storing propellant at a pressure greater than two hundred (200) psi and delivering the propellant to the fastener device.

2. A fastener system as claimed in claim 1, further comprising a regulator for controlling flow pressure.

3. A fastener system as claimed in claim 1, further comprising a carrying apparatus for carrying various components/accessories.

4. A fastener system as claimed in claim 1, further comprising a transfer hose for transferring propellant from the reservoir to the fastener device.

5. A fastener system as claimed in claim 1, wherein the reservoir includes a fill indicator for indicating the amount of propellant remaining in the reservoir.

6. A fastener system as claimed in claim 1, wherein the reservoir is configured with a safety valve for allowing for propellant release due to pressure build-up.

7. A fastener system as claimed in claim 1, wherein the propellant is compressed carbon dioxide.

8. A method for securing one or more fasteners, comprising the steps of:
storing propellant within a reservoir at a first pressure;
delivering propellant from the reservoir to a connected fastener device at a second pressure; and,
utilizing the propellant to secure one or more fasteners;
wherein the first pressure is greater than 200 psi.

9. A method as claimed in claim 8, wherein the propellant is a compressed inert gas.

10. A method as claimed in claim 8, wherein the propellant is stored as a compressed gas, liquid or in multiple phases.

11. A method as claimed in claim 8, wherein the propellant is compressed carbon dioxide.

12. A method as claimed in claim 8, wherein the propellant is delivered to the connected fastener device via a transfer hose.

13. A method as claimed in claim 8, wherein a regulator assists in allowing the propellant to be delivered to the fastener device at a second pressure.

14. A method as claimed in claim 8, wherein the fastener device is a pneumatic fastener device.
